(19) United States
(12) Patent Application Publication
(10) Pub. No.: US 2026/0339371 A1
(43) Pub. Date: Oct. 29, 2026

(54) CONFIGURATION METHOD, ELECTRONIC DEVICE, AND STORAGE MEDIUM

(71) Applicant: Lenovo (Beijing) Limited, Beijing (CN)

(72) Inventors: Ching-Te CHIEN, Beijing (CN); Fan YANG, Beijing (CN)

(21) Appl. No.: 19/550,730

(22) Filed: Feb. 26, 2026

(30) Foreign Application Priority Data
Mar. 2, 2025 (CN) 202510240305.8

(51) Int. Cl. G05D 23/19

(52) U.S. Cl. CPC G05D 23/1917; G05D 23/1919

(57) ABSTRACT

Configuration method is provided. The configuration method includes configuring an electronic device to operate in a first cooling mode or a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table includes M switchable, mutually different second operating parameters, where M is greater than 1. Upon switching from one second operating parameter to another second operating parameter, the electronic device maintains the switched second operating parameter for a second target duration.

### CROSS-REFERENCE TO RELATED APPLICATION

This application claims priority of Chinese Patent Application No. 2025102403058, filed on Mar. 2, 2025, the entire contents of which are hereby incorporated by reference.

### FIELD OF THE DISCLOSURE

The present disclosure generally relates to the field of control technology and, more particularly, relates to a configuration method.

### BACKGROUND

During operation of an electronic device, heat generated by components thereof may cause an internal temperature of the electronic device to rise, and a fan is generally used to cool the electronic device.

In related technologies, to avoid generating excessive noise during fan rotation, a fan speed is controlled by a board temperature. Furthermore, to mitigate sudden noise increases caused by an increasing fan speed, the fan speed may be increased in a plurality of incremental adjustments. In the above implementations, adjacent fan speeds are increased sequentially, and a delay is introduced after each adjustment to reduce rapid fluctuations between different speeds.

However, when a sudden high-power cooling demand occurs, the component responds by rapidly increasing power consumption, and the fan correspondingly increases the fan speed to match the demand. Because fan speed is generally proportional to generated noise, a sudden increase in the fan speed can cause a sudden increase in noise, resulting in poor user experience.

### BRIEF SUMMARY OF THE DISCLOSURE

One aspect of the present disclosure provides a configuration method. The configuration method includes configuring an electronic device to operate in one of a first cooling mode and a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table comprises M switchable, mutually different second operating parameters, where M is greater than 1. Upon switching from one second operating parameter to another second operating parameter, the electronic device maintains the switched second operating parameter for a second target duration. M is the same as or different from N. The first operating parameters characterize a cooling capability of the first cooling mode, and the second operating parameters characterize a cooling capability of the second cooling mode. The first target duration is greater than the second target duration. Any first value in the first control table is less than any second value in the second control table.

Another aspect of the present disclosure provides an electronic device including one or more processors and a memory connected to the one or more processors. The memory is used to store computer programs. The one or more processors are configured to execute the computer programs so that the electronic device operates in a first cooling mode or a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table comprises M switchable, mutually different second operating parameters, where M is greater than 1. Upon switching from one second operating parameter to another second operating parameter, the electronic device maintains the switched second operating parameter for a second target duration. M is the same as or different from N. The first operating parameters characterize a cooling capability of the first cooling mode, and the second operating parameters characterize a cooling capability of the second cooling mode. The first target duration is greater than the second target duration. Any first value in the first control table is less than any second value in the second control table.

Another aspect of the present disclosure provides a non-transitory computer readable storage medium containing computer programs that, when being executed, cause at least one processor to perform: configuring an electronic device to operate in one of a first cooling mode and a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table comprises M switchable, mutually different second operating parameters, where M is greater than 1. Upon switching from one second operating parameter to another second operating parameter, the electronic device maintains the switched second operating parameter for a second target duration. M is the same as or different from N. The first operating parameters characterize a cooling capability of the first cooling mode, and the second operating parameters characterize a cooling capability of the second cooling mode. The first target duration is greater than the second target duration. Any first value in the first control table is less than any second value in the second control table.

Another aspect of the present disclosure provides a configuration device. The configuration device configures an electronic device to operate in a first cooling mode or a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table comprises M switchable, mutually different second operating parameters, where M is greater than 1. Upon switching from one second operating parameter to another second operating parameter, the electronic device maintains the switched second operating parameter for a second target duration. M is the same as or different from N. The first operating parameters characterize a cooling capability of the first cooling mode, and the second operating parameters characterize a cooling capability of the second cooling mode. The first target duration is greater than the second target duration. Any first value in the first control table is less than any second value in the second control table.

Another aspect of the present disclosure provides a computer program product including computer-readable instructions that, when executed by an electronic device, enable the electronic device to operate in a first cooling mode or a second cooling mode. The first cooling mode includes a first control table, and the second cooling mode includes a second control table. The first control table includes N switchable, mutually different first operating parameters, where N is greater than 1. Upon switching from one first operating parameter to another first operating parameter, the electronic device maintains the switched first operating parameter for a first target duration. The second control table comprises M switchable, mutually different second operating parameters, where M is greater than 1. Upon switching from one second operating parameter to another second operating parameter, the electronic device maintains the switched second operating parameter for a second target duration. M is the same as or different from N. The first operating parameters characterize a cooling capability of the first cooling mode, and the second operating parameters characterize a cooling capability of the second cooling mode. The first target duration is greater than the second target duration. Any first value in the first control table is less than any second value in the second control table.

Other aspects of the present disclosure can be understood by a person skilled in the art in light of the description, the claims, and the drawings of the present disclosure.

### BRIEF DESCRIPTION OF THE DRAWINGS

The above and other features, advantages, and aspects of embodiments of the present disclosure will become more apparent from the following detailed description with reference to accompanying drawings. Throughout the accompanying drawings, like or similar reference numerals refer to like or similar elements. The accompanying drawings are schematic and that components and elements are not necessarily drawn to scale.

FIG. 1 illustrates a schematic diagram of an electronic device using a configuration method consistent with various embodiments of the present disclosure.

FIG. 2 illustrates a flowchart for controlling a cooling module based on target information consistent with various embodiments of the present disclosure.

FIG. 3 illustrates a flowchart for controlling a cooling module to operate in a first cooling mode based on operational information satisfying a first condition consistent with various embodiments of the present disclosure.

FIG. 4 illustrates a flowchart for determining whether target information satisfies either the first condition or a second condition consistent with various embodiments of the present disclosure.

FIG. 5 illustrates a flowchart for determining target information based on operational information of a target device in an electronic device consistent with various embodiments of the present disclosure.

FIG. 6 illustrates a flowchart for analyzing a plurality of pieces of operational information in advance for different operating scenarios and selecting target information consistent with various embodiments of the present disclosure.

FIG. 7 illustrates a schematic diagram of combined operational information and target information curves for two operating scenarios consistent with various embodiments of the present disclosure.

FIG. 8 illustrates a schematic diagram of combined operational information and target information for two operating scenarios, along with corresponding curves for operating parameters consistent with various embodiments of the present disclosure.

FIG. 9 illustrates a flowchart for analyzing target information and determining how the target information changes within a preset time frame consistent with various embodiments of the present disclosure.

FIG. 10 illustrates another schematic diagram of an electronic device consistent with various embodiments of the present disclosure.

FIG. 11 illustrates a schematic diagram of curves of operational information and target information in an application scenario consistent with various embodiments of the present disclosure.

FIG. 12 illustrates a flowchart for determining a response method to sudden high power dissipation demands when the cooling module is operating in the first cooling mode consistent with various embodiments of the present disclosure.

FIG. 13 illustrates a flowchart for switching between operating modes of an electronic device consistent with various embodiments of the present disclosure.

FIG. 14 illustrates a schematic diagram of another electronic device consistent with various embodiments of the present disclosure.

### DETAILED DESCRIPTION

The embodiments of the present disclosure are described below with reference to the accompanying drawings. Terminologies used herein are for explaining specific embodiments and are not intended to limit the present disclosure. A person skilled in the art will understand that, as technology evolves and new applications emerge, technical solutions provided herein are also applicable to similar technical problems.

Terms “first”, “second”, and the like used in the specification, claims, and accompanying drawings of the present disclosure are used to distinguish similar objects and are not necessarily intended to describe a specific order or sequence. It should be understood that these terms, as used herein, may be used interchangeably in appropriate circumstances and are provided merely to distinguish objects having same properties in the embodiments of the present disclosure. Furthermore, terms “comprising” and “having”, and any variations thereof, are intended to cover non-exclusive inclusion, so that a process, method, system, product, or device having a series of elements is not limited to the elements but may include other elements not explicitly listed or inherent to the process, method, product, or device.

The present disclosure provides a configuration method that can be applied to an electronic device. The electronic device includes a cooling module, which is used to dissipate heat from the electronic device.

FIG. 1 illustrates a schematic diagram of an electronic device using a specific configuration method consistent with various embodiments of the present disclosure. The electronic device includes a target device 101, a cooling module 102, and a functional module 103. The target device 101 can be a device requiring cooling, the cooling module 102 can be a structure for dissipating heat from the target device, and the functional module 103 can be a module that applies the configuration method provided in the embodiments. The configuration method performed by the functional module is described in detail below.

The configuration method includes configuring the electronic device to operate in either a first cooling mode or a second cooling mode. The first cooling mode includes a first control table, and the second cooling mode includes a second control table.

The first control table includes N different, switchable first operating parameters, where N is greater than 1. Each of N first operating parameters is maintained for a first target duration after switching. A lower limit value of each of N first operating parameters is a first value.

The second control table includes M different, switchable second operating parameters, where M is greater than 1. Each of the M second operating parameters is maintained for a second target duration after switching. A lower limit value of each of M second operating parameters is a second value. M may be the same as or different from N. The first operating parameters and the second operating parameters characterize a cooling capacity of the cooling mode.

The first target duration can be greater than the second target duration, and any first value in the first control table can be less than any second value in the second control table.

In one embodiment, the first cooling mode or second cooling mode can be configured to cool the electronic device in response to a command to switch a cooling mode of the electronic device.

In another embodiment, the cooling mode of the electronic device can be automatically switched to improve a cooling efficiency of the electronic device.

The cooling mode for the electronic device can be configured as either the first cooling mode or the second cooling mode, each cooling mode including a corresponding control table. The control tables for different cooling modes are different.

Noise generated when the electronic device performs cooling using different operating parameters may vary with the operating parameters. Generally, as a value of an operating parameter increases, the noise generated increases.

For example, the cooling module of the electronic device uses a fan, and a fan speed may be an operating parameter. As the fan speed increases, noise generated by the electronic device may increase. As the fan speed decreases, the noise generated by the electronic device may decrease.

The first control table includes N different first operating parameters, which can be arranged in a predetermined order, such as in an ascending order. Accordingly, during a cooling process using the first cooling mode, the electronic device can switch sequentially according to the first operating parameters in the first control table, and each switch of the first operating parameters is maintained for the first target duration.

The first control table corresponding to the first cooling mode includes a plurality of first operating parameters that control operation of the cooling module in the first cooling mode.

For example, when the cooling module is a fan, a first operating parameter can be a fan speed. When the cooling module includes a plurality of fans, the first operating parameters can include a respective fan speed of each fan.

The first control table includes N different, switchable first operating parameters, which can be arranged in a predetermined order.

In one embodiment, the predetermined order can be an ascending order.

Each of the first operating parameters may include a plurality of values, each value corresponding to a respective structure in the cooling module, and an operation of the respective structure is controlled using a corresponding value.

For example, when the cooling module includes two fans, the first operating parameters can include a rotational speed of each fan, and rotational speeds of the two fans can be different.

Specifically, each time a first operating parameter is switched, the first operating parameter is maintained for the first target duration. After the cooling module switches to the first operating parameter, the first target duration remains unchanged.

In one embodiment, the first target duration can be added to the first control table.

When the cooling module is operating in the first cooling mode, the operating parameters of the cooling module can be switched using a first operating parameter on the first control table.

For example, the fan speed can be switched according to switching values of the fan speed in Table 1, and the arranged first target duration is maintained after each switch.

Maintaining the first target duration means that the fan speed is not switched within the first target duration, and switching occurs only after the first target duration ends. The switching refers to switching to a value of the operating parameter value in a next step in the first control table, or switching the cooling mode, which is not limited herein.

Table 1 below shows the first control table corresponding to the first cooling mode. The cooling module includes two fans (Fan 1 and Fan 2), and the first control table includes the fan speeds of both two fans.

TABLE 1

| Step | Fan 1 Speed (RPM) | Fan 2 Speed (RPM) |
|---|---|---|
| 1 | 1600 | 1700 |
| 2 | 1900 | 2000 |
| 3 | 2200 | 2200 |
| 4 | 2300 | 2400 |
| 5 | 2600 | 2500 |
| 6 | 2900 | 2700 |
| 7 | 3300 | 3100 |
| 8 | 3600 | 3400 |
| 9 | 3800 | 3700 |
| 10 | 4200 | 4100 |

As shown in Table 1 above, when the cooling module enters a first operating mode, the fan speed is controlled and switched according to a sequence of steps in Table 1.

For example, when entering the first operating mode, the fan speed can be controlled starting from step n (where n is any number from 1 to 9) and sequentially increased according to the fan speeds corresponding to step n, step (n+1), and subsequent steps.

In the first control table, a lower limit of the fan speed of Fan 1 is 1600 rpm, and a lower limit of the fan speed of Fan 2 is 1700 rpm.

Accordingly, in the first cooling mode, the first target duration can be a longer duration, such as 8 seconds, 10 seconds, or the like.

During a cooling module switching process, Fan 1 is switched from 1900 rpm to 2200 rpm, and Fan 2 is switched from 2000 rpm to 2200 rpm. The speeds are maintained for 8 seconds. After 8 seconds, the fan speeds are increased again, so that Fan 1 is switched from 2200 rpm to 2300 rpm, and Fan 2 is switched from 2200 rpm to 2400 rpm. The process continues, with each switch to a next set of operating parameters being maintained for the first target duration.

The second control table is arranged for the second cooling mode. The second control table includes a plurality of second operating parameters, which are parameters that control an operation of the cooling module in the second cooling mode.

For example, when the cooling module is a fan, the second operating parameter can be a fan speed. When the cooling module includes a plurality of fans, the second operating parameter includes a respective fan speed of each fan.

Each of the second operating parameters can include a plurality of values, with each value corresponding to a respective component within the cooling module. Operation of each component is controlled using the corresponding value.

For example, the cooling module could consist of two fans, and the second operating parameter would include a rotational speed of each fan, which can be different for each fan.

For example, the cooling module can include two fans, and the second operating parameter can include a respective rotational speed of each fan, which may be different for the two fans.

The second operating parameter maintains the second target duration each time it is switched. After the cooling module switches to using the second operating parameter, the second target duration can be maintained without change.

In one embodiment, the second target duration can be corresponding to the second control table. Each first value in the first control table is less than a corresponding second value in the second control table.

When the cooling module is operating in the second cooling mode, the second operating parameters in the second control table can be used to control switching among operating parameters of the cooling module.

Table 2 below shows the second control table corresponding to the second cooling mode. The cooling module includes two fans (Fan 1 and Fan 2), and the second control table includes the fan speeds of both two fans.

TABLE 2

| Step | Fan 1 Speed (RPM) | Fan 2 Speed (RPM) |
|---|---|---|
| 1 | 2500 | 2300 |
| 2 | 2800 | 2600 |
| 3 | 3100 | 2900 |
| 4 | 3400 | 3300 |
| 5 | 3600 | 3600 |
| 6 | 3900 | 3700 |
| 7 | 4300 | 4100 |
| 8 | 4600 | 4400 |
| 9 | 4800 | 4700 |
| 10 | 5200 | 5100 |

As shown in Table 2, when the cooling module enters a second operating mode, the fan speed is controlled and switched according to a sequence of steps shown in Table 2.

In the first control table, a lower limit of the fan speed of Fan 1 is 1600 rpm, and a lower limit of the fan speed of Fan 2 is 1700 rpm. In the second control table, a lower limit of the fan speed of Fan 1 is 2500 rpm, and a lower limit of the fan speed of Fan 2 is 2300 rpm.

For example, the fan speed can be switched among the fan speeds in Table 2. After each switch, the fan speed is maintained for the second target duration.

The second target duration is a period during which the fan speed remains unchanged. Switching occurs only after the second target duration ends. The switching refers to switching to a value of the operating parameter value in a next step in the second control table, or switching the cooling mode, which is not limited thereto.

Accordingly, in the second cooling mode, the second target duration can be a shorter duration, such as 4 seconds, 5 seconds, or the like.

During a cooling module switching process, Fan 1 is switched from 2500 rpm to 2800 rpm, and Fan 2 is switched from 2300 rpm to 2600 rpm. The above state is maintained for 5 seconds. After 5 seconds, the fan speeds are increased again: Fan 1 is switched from 2800 (rpm) to 3100 rpm, and Fan 2 is switched from 2600 rpm to 2900 rpm. The process continues, with each switch to a next set of operating parameters being maintained for the second target duration.

The cooling module for the electronic device is configured with two different cooling modes: the first cooling mode and the second cooling mode. In the first control table corresponding to the first cooling mode, any first value is less than any second value in the second control table. The first values and the second values correspond to cooling capacities of the respective cooling modes, with the first cooling mode having a lower cooling capacity than the second cooling mode. However, the first target duration for the first cooling mode is greater than the second target duration for the second cooling mode.

Because the cooling module has a lower cooling capacity in the first cooling mode, operating parameters of the cooling module have smaller values. As a result, the cooling module generates less noise during a cooling process, allowing the electronic device to maintain a lower overall noise level and enabling a longer target operating time. When a sudden high-power cooling demand occurs, the cooling module maintains the first operating parameters for a target duration. During the target duration, the cooling module does not switch operating parameters. Therefore, for a sudden high-power cooling demands having a duration shorter than the target duration, the cooling module may refrain from switching operating parameters. Accordingly, in the first cooling mode, the cooling module is less likely to respond to a short-duration, sudden high-power cooling demand, thereby maintaining a lower noise level of the electronic device and making the electronic device quieter during use.

Because the cooling module has a greater cooling capacity in the second cooling mode, operating parameters of the cooling module have higher values, resulting in a higher noise level during cooling. However, the second cooling mode provides improved cooling performance and may maintain the electronic device at an optimal performance level, thereby allowing a shorter target duration.

In one embodiment, the electronic device is configurable to operate in a first cooling mode or a second cooling mode, and different control tables are provided for the different cooling modes. The first control table corresponding to the first cooling mode includes N different, switchable first operating parameters. Each of the N first operating parameters is maintained for the first target duration after each switch, and a lower-limit value of each of the N first operating parameters is a first value. The second control table corresponding to the second cooling mode includes M different, switchable second operating parameters. Each of the M second operating parameters is maintained for the second target duration after each switch, and a lower-limit value of each of the M second operating parameters is a second value. M and N are the same or different positive integers. The first target duration is greater than the second target duration, and any first value in the first control table is less than any second value in the second control table. In the first cooling mode, a lower minimum value is set for the first operating parameters, and the first target duration is longer, thereby reducing responses of the cooling module to a sudden high-power cooling demand and maintaining the electronic device at a lower noise level. In the second cooling mode, a higher minimum value is set for the second operating parameters, and the second target duration is shorter, thereby enabling the cooling module to respond more quickly to a sudden high-power cooling demand and maintaining the electronic device at an optimal performance level.

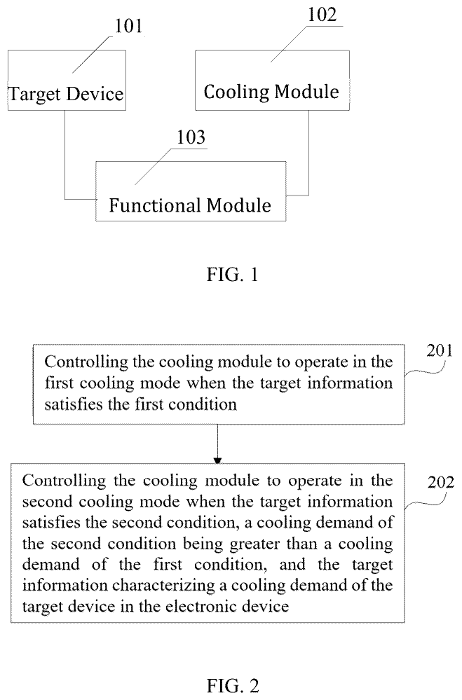

In one possible implementation, after target information is determined, the cooling module of the electronic device can be controlled by using either of two cooling modes based on the target information. The specific implementation process is shown in FIG. 2.

FIG. 2 illustrates a flowchart for controlling a cooling module based on target information consistent with various embodiments of the present disclosure. The process includes steps 201 to 202, which are described in detail below.

201: controlling the cooling module to operate in the first cooling mode when the target information satisfies the first condition.

202: controlling the cooling module to operate in the second cooling mode when the target information satisfies the second condition, a cooling demand of the second condition being greater than a cooling demand of the first condition, and the target information characterizing a cooling demand of the target device in the electronic device.

The first condition and the second condition are preset, and a cooling demand of the second condition is greater than a cooling demand of the first condition.

The first condition and the second condition correspond to different cooling demands. Accordingly, a first cooling mode can provide a cooling capacity that satisfies the cooling demand of the first condition, and a second cooling mode can provide a cooling capacity that satisfies the cooling demand of the second condition.

Whether the target information satisfies the first condition or the second condition can be determined, and the first condition and the second condition are mutually exclusive. If the target information satisfies the first condition, the target information does not satisfy the second condition. If the target information does not satisfy the first condition, the target information satisfies the second condition.

Based on a combination of at least two pieces of operational information, the determined target information satisfies the first condition, indicating that the cooling demand of the target device during operation satisfies the first condition, the target device has a low cooling demand. Accordingly, the cooling module can be controlled to operate in the first cooling mode. If the determined target information satisfies the second condition, the cooling demand of the target device during operation satisfies the second condition, the target device has a high cooling demand. Accordingly, the cooling module can be controlled to operate in the second cooling mode.

In one embodiment, the first condition and the second condition can be determined using a threshold. The first condition is satisfied if the target information is less than the predetermined threshold. The second condition is satisfied if the target information is not less than the predetermined threshold.

In another embodiment, to achieve more refined control, additional conditions can be set to further categorize cooling demands of the target device. Correspondingly, the cooling module can be configured with additional cooling modes to provide an appropriate cooling capacity for different cooling demands.

In one embodiment, the first condition and the second condition characterize different cooling demands of the target device. The determined target information satisfies either the first condition or the second condition, and the cooling module is controlled to operate in different cooling modes based on which condition is satisfied. Therefore, the selected cooling mode matches the cooling demands of the target device, thereby enabling more accurate temperature control and improved performance of the electronic device.

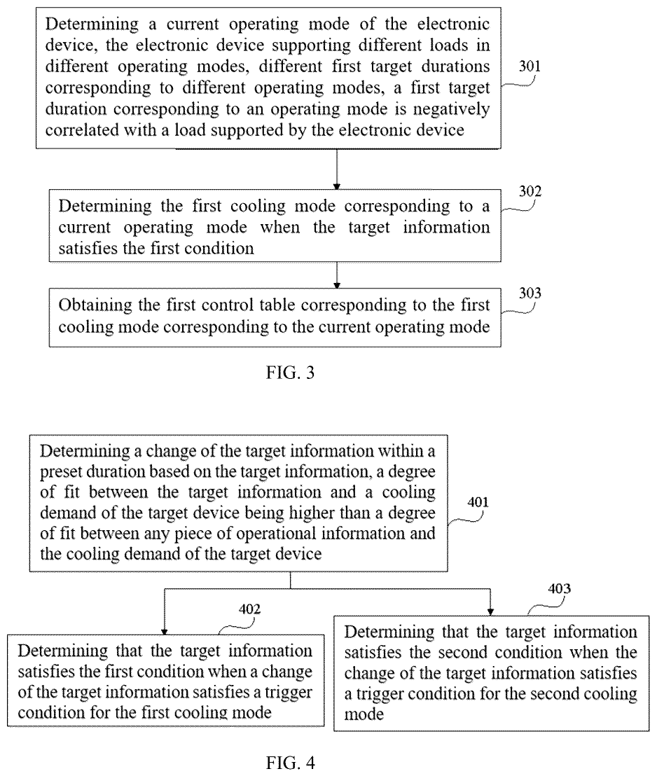

In one embodiment, two cooling modes can be controlled based on the operating mode of the electronic device. A specific implementation process is shown in FIG. 3.

FIG. 3 illustrates a flowchart for controlling the cooling module to operate in the first cooling mode based on operational information satisfying the first condition consistent with various embodiments of the present disclosure. The process may include steps 301-304, which are described in detail below.

301: determining a current operating mode of the electronic device, the electronic device supporting different loads in different operating modes, different first target durations corresponding to different operating modes, a first target duration corresponding to an operating mode is negatively correlated with a load supported by the electronic device.

The electronic device can operate in different operating modes. The electronic device can support different loads in different operating modes.

The loads supported by the electronic device are different, and the target durations in the control table correspond to different operating modes. Moreover, the target duration can be negatively related to a load supported by the electronic device.

When the electronic device operates in an operating mode that supports a lower load, a corresponding target duration is longer, and when the electronic device operates in an operating mode that supports a higher load, a corresponding target duration is shorter.

When the operating mode of the electronic device supports a lower load, a balance between load and noise can be achieved to reduce noise as much as possible. Accordingly, to reduce responses to a sudden high-power cooling demand to maintain a low-noise state, the first target duration corresponding to a first cooling mode associated with the lower load may be set to a longer duration.

When the operating mode of the electronic device supports a higher load, the electronic device prioritizes performance. Although the electronic device operates in the first cooling mode, the cooling module may be controlled to maintain a higher performance level than in the operating mode that supports a lower load. Accordingly, to respond more quickly to a sudden high-power cooling demand and maintain optimal performance, the first target duration for the first cooling mode under a higher load may be shorter than the first target duration for the first cooling mode under a lower load.

For example, when the electronic device is in the first operating mode that supports low a load, the first target duration is 10 seconds, and when the electronic device is in the second operating mode that supports a high load, the first target duration is 8 seconds.

302: determining the first cooling mode corresponding to a current operating mode when the target information satisfies the first condition.

If the target information satisfies the first condition, the first cooling mode corresponding to the current operating mode of the electronic device can be determined.

If the current operating mode of the electronic device is the first operating mode that supports a low power consumption, the first cooling mode corresponding to the first operating mode can be determined.

If the current operating mode of the electronic device is the second operating mode that supports a high power consumption, the first cooling mode corresponding to the second operating mode can be determined.

In one embodiment, a same first condition can be used for judgment across different operating modes of the electronic device.

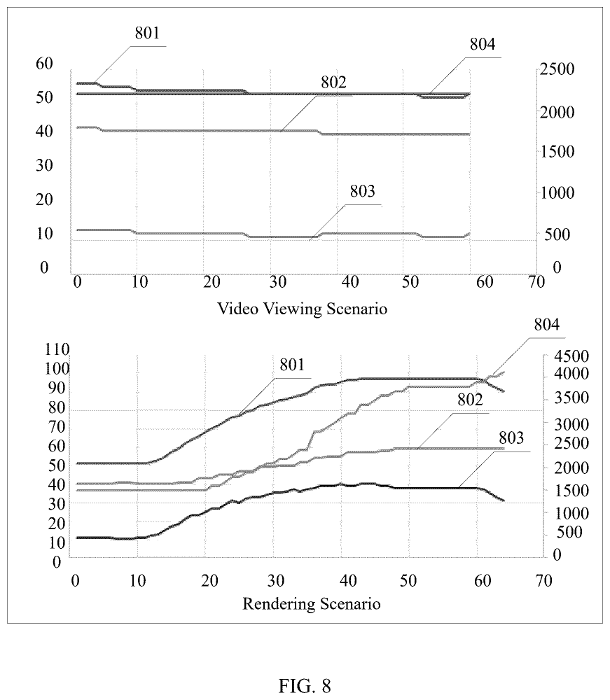

In one embodiment, a process shown in FIG. 8 is performed in advance to determine the first condition and the second condition corresponding to the target information for different operating modes of the electronic device.

For example, the first condition could be less than or equal to a predetermined threshold, and the second condition could be greater than the predetermined threshold.

303: obtaining the first control table corresponding to the first cooling mode corresponding to the current operating mode.

After determining the first cooling mode corresponding to the current operating mode, the first control table corresponding to that current operating mode and first cooling mode can be obtained.

The first control table includes a plurality of first operating parameters, each of which is maintained for the first target duration after each switch.

In one embodiment, the first control tables corresponding to the first cooling modes corresponding to different operating modes may be different.

For example, in the operating mode supporting a lower load, the first control table may contain a smaller subset of operating parameters, such as steps 1-7 or steps 1-5 from Table 1, to provide a lower minimum speed. In the operating mode supporting a higher load, the first control table may contain a larger subset of operating parameters, such as steps 6-10 or steps 3-10 from Table 1, to provide a higher minimum speed.

In one embodiment, like the first control table corresponding to the first cooling mode, the second control table corresponding to the second cooling mode can be determined based on operational information satisfying the second condition after a current operating mode of the electronic device is determined, and details thereof are not repeated herein.

Because the second cooling mode is used to increase cooling to maintain higher performance of the target device and to respond quickly to a sudden high-power cooling demand, the second target duration for the second cooling mode under a low-load operating mode and a high-load operating mode may be the same or different.

For example, when the electronic device is in the first operating mode supporting a low load, the second target duration is 5 seconds and when the electronic device is in the second operating mode supporting a high load, the second target duration is 4 seconds.

For example, when the electronic device is in the first operating mode supporting a low load or in the second operating mode supporting a high load, the second target duration can be 5 seconds in either case.

In one embodiment, a current operating mode of the electronic device is determined. The electronic device supports different loads in different operating modes. Different first target durations correspond to different operating modes, and a first target duration corresponding to an operating mode is negatively correlated with a load supported by the electronic device. Based on the target information satisfying the first condition, the first cooling mode corresponding to the current operating mode is determined and the first control table corresponding to the first cooling mode corresponding to the current operating mode is obtained. According to different operating modes of the electronic device, two different cooling modes are set to control operation of the cooling mode in a more detailed manner, thereby achieving accurate cooling control of the target device.

In one embodiment, it is determined which condition is satisfied based on a value and/or change of the target information. A specific implementation process is shown in FIG. 4.

FIG. 4 illustrates a flowchart for determining whether target information satisfies either the first condition or a second condition consistent with various embodiments of the present disclosure. The process may include steps 401 through 403, which are described in detail below.

401: determining changes of the target information within a preset duration based on the target information, a degree of fit between the target information and a cooling demand of the target device being higher than a degree of fit between any piece of operational information and the cooling demand of the target device.

According to a preset duration, the target information is analyzed and processed to determine changes of the target information.

The changes may include two different trends, and the two trends occur continuously within the preset duration.

For example, the target information can be calculated based on values of at least two pieces of operational information. The changes may include a value of the target information changing from a stable value to a gradually increasing value or changing from a gradually increasing value to a gradually decreasing value and maintaining a stable value, or the like.

During operation, changes in various operating parameters of the target device are influenced by cooling demands of the target device. A correlation between the target information and the cooling demands of the target device is higher than a correlation between any other operating parameter and the cooling demands of the target device. Accordingly, the target information may be used to more accurately determine the cooling demands of the target device, thereby providing a reliable basis for subsequently selecting an appropriate cooling mode.

The changes in the target information are influenced by the cooling demands of the target device. Therefore, by utilizing the changes in the target information over a preset period, the changes in the cooling demands of the target device during the preset period can be determined.

For example, the target information may be determined based on a temperature of the target device and a load of the target device. In one example, the target information includes a ratio of a load value to a temperature value. When a current temperature of the target device is high and a current load is also high, the value of the target information may remain substantially stable. When the current temperature of the target device is high and the current load decreases, the value of the target information may decrease. In general, a higher load on the target device corresponds to a higher cooling demand. When the load decreases, even if the temperature remains high, the ratio correspondingly decreases, which is consistent with a reduced cooling demand of the target device. Accordingly, changes in the target information, determined based on both the temperature and the load of the target device, may be used to determine the cooling demand of the target device. If the cooling demand is determined using only temperature, the temperature may remain high after the load decreases, which can make it difficult to detect that the cooling demand has begun to decrease. If the cooling demand is determined using only load, the load may decrease while the temperature remains high, which can make it difficult to determine whether the cooling demand remains high or is decreasing.

For example, the target information may be determined based on a temperature of the target device and an onboard temperature. In one example, the target information includes a difference between the temperature of the target device and the onboard temperature. Changes in the target information may be used to determine a cooling demand of the target device. The difference represents a temperature difference between a temperature of a circuit board on which the target device is installed and the temperature of the target device. Based on the difference, it may be determined whether the target device has experienced a rapid temperature rise, thereby determining a change in cooling demand of the target device within the preset period. An implementation process is described in subsequent embodiments.

402: determining that the target information satisfies the first condition when a change of the target information satisfies a trigger condition for the first cooling mode.

403: determining that the target information satisfies the second condition when the change of the target information satisfies a trigger condition for the second cooling mode.

A cooling demand associated with the second condition may be greater than a cooling demand associated with the first condition.

The trigger conditions for the first cooling mode and the second cooling mode are preset.

The first cooling mode has a lower cooling capacity. Therefore, the trigger condition for the first cooling mode may be set to a lower value. The second cooling mode has a higher cooling capacity. Therefore, the trigger condition for the second cooling mode may be set to a higher value.

In one embodiment, the trigger condition for the first cooling mode could be that the change in the target information transitions from a fluctuating trend to a stable state, and the trigger condition for the second cooling mode could be that the change in the target information transitions from a stable state to a fluctuating trend.

For example, the trigger condition for the first cooling mode may be that a value of the target information is within a preset range, for example, less than a predetermined threshold. The trigger condition for the second cooling mode may be that the value of the target information is outside the preset range, for example, greater than or equal to the predetermined threshold.

If the change in the target information satisfies the trigger condition of the first cooling mode, the target device has a lower cooling demand, and the first cooling mode having a lower cooling capacity may be used. If the change in the target information satisfies the trigger condition of the second cooling mode, the target device has a higher cooling demand, and the second cooling mode having a higher cooling capacity may be used.

In one embodiment, the change in the target information within a preset duration is determined based on target information determined using at least two pieces of operational information. If the change satisfies the trigger condition of the first cooling mode, it is determined that the target information satisfies the first condition, and the cooling module is controlled to operate in the first cooling mode. If the change satisfies the trigger condition of the second cooling mode, it is determined that the target information satisfies the second condition, and the cooling module is controlled to operate in the second cooling mode. Because changes in the target information of the target device reflect changes in the cooling demand of the target device, the cooling module can accurately determine the cooling demand based on the target information. By selecting a corresponding cooling mode according to the determined cooling demand, accurate cooling mode selection is achieved.

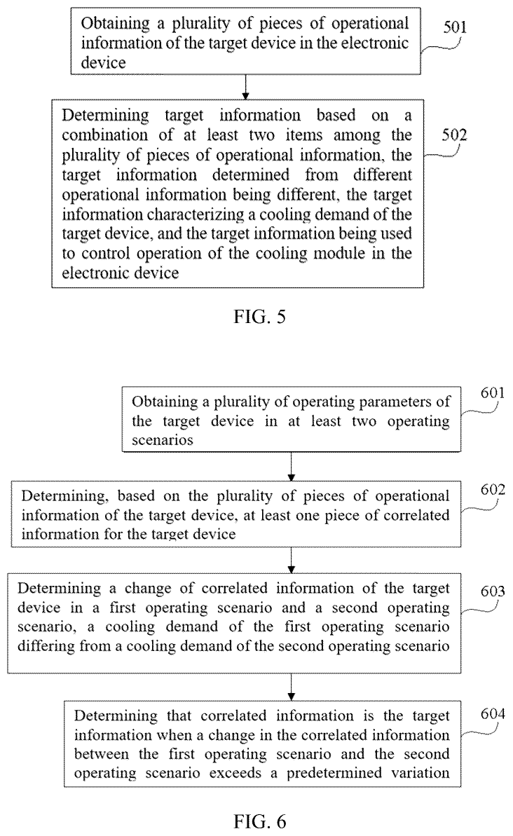

In one possible implementation, the target information can be determined based on operational information of the target device in the electronic device. The specific implementation process is shown in FIG. 5.

FIG. 5 illustrates a flowchart for determining target information based on operational information of a target device in an electronic device consistent with various embodiments of the present disclosure. The process may include steps 501 to 502, which are described in detail below.

501: obtaining a plurality of pieces of operational information of the target device in the electronic device.

During operation of the electronic device, the target device may be monitored to obtain the plurality of pieces of operational information.

The operational information may include parameters used for operating the target device, parameters generated during operation of the target device, and parameters affected by operation of the target device.

For example, when the target device is a chip-on-board device, the operational information of the target device may include a chip temperature, a chip current, a chip power consumption, a board temperature, a board current, and the like. Specific types of the operational information may be set according to actual circumstances and are not limited by the present disclosure.

For example, if the target device is a standalone component, the operational information of the target device may include a temperature of the component, a current of the component, and an ambient temperature. Specific types of operational information can be set according to actual circumstances and are not limited in the present disclosure.

The operating parameters to be obtained may be determined in advance and acquired during operation of the target device according to a predetermined detection cycle.

502: determining target information based on a combination of at least two items among the plurality of pieces of operational information, the target information determined from different operational information being different, the target information characterizing a cooling demand of the target device, and the target information being used to control operation of the cooling module in the electronic device.

From a plurality of pieces of operational information that are obtained, two or more pieces of the operational information may be combined to determine the target information.

The combined operational information may be processed to determine the target information, and different combinations of the operational information may result in different target information.

For example, when the target device is a chip-on-board device, the operational information of the target device may include chip temperature, chip current, chip power consumption, onboard temperature, onboard current, and the like. The target information may be determined based on, for example: chip temperature and chip current; chip temperature and onboard temperature; chip load and onboard temperature, or chip temperature, chip current, chip power consumption, and onboard temperature, among other combinations.

The target information is determined by each piece of operational information within an operational information combination. The target information may be obtained by applying a calculation method to respective pieces of operational information.

For example, the calculation method can be one or more mathematical operations, such as addition, subtraction, multiplication, and division, or any combination thereof.

The operational information combination corresponding to the target information can be predetermined. When the operational information combination is obtained, specific pieces of operational information corresponding to the operational information combination may be retrieved and the operational information combination can be directly processed to determine the target information. There is no need to obtain or calculate remaining pieces of operational information, thereby reducing a data processing burden.

For example, onboard temperature and chip temperature can be predetermined as specific pieces of operational information for determining the target information. During a process of obtaining the plurality of pieces of operational information to determine the target information, it is not necessary to obtain remaining parameters such as chip current and chip power consumption, and the remaining parameters do not need to be corresponding to calculations, thereby reducing a data processing burden.

For example, chip power consumption and onboard temperature can also be predetermined as specific pieces of operational information for determining the target information. During a process of obtaining the plurality of pieces of operational information to determine the target information, it is not necessary to obtain remaining parameters such as chip current and chip temperature, and the remaining parameters do not need to be corresponding to calculations, thereby reducing a data processing burden.

However, the present disclosure does not specifically limit which types of operational information are used for determining the target information. A person skilled in the art can arrange and adjust the operational information according to actual circumstances.

Referring to the electronic device shown in FIG. 1, the functional module 103 can obtain a plurality of pieces of operational information of the target device, determine the target information, and use the target information to control the cooling module 102. The cooling module 102 can dissipate heat from the target device under control of the functional module 103. The target information can be determined by combining two or more pieces of operational information from an operational information combination, thereby incorporating characteristics of the plurality of pieces of operational information. Since an individual piece of operational information may represent a state at a corresponding data acquisition location, the target information combines characteristics of the plurality of operating parameters and determines the cooling demand based on a multi-dimensional analysis. Compared with a single-dimensional analysis in the cooling demand, the multi-dimensional analysis is more accurate and closely aligned with the cooling demand of the current target device.

In one embodiment, a plurality of operating parameters of the target device in the electronic device are obtained. At least two of the plurality of operating parameters are combined to determine the target information that represents the cooling demand of the target device. The target information is used to control operation of the cooling module in the electronic device. Different operating parameters result in different target information. By determining target information using a plurality of pieces of operational information, where the target information can represent the cooling demand of the target device, the target information is obtained that integrates characteristics of respective pieces of operational information in the operational information combination. The determined target information, compared with an individual piece of operational information, more effectively reflects the cooling demand of the target device during operation. Therefore, the target information can be used to more accurately control operation of the cooling module. Furthermore, during heat dissipation using two cooling modes, when a sudden high-power cooling demand occurs, the electronic device can respond more efficiently to the sudden high-power cooling demand, thereby reducing noise and enabling quieter operation of the electronic device.

In one possible implementation, before obtaining the plurality of pieces of operational information from the target device in the electronic device, the plurality of pieces of operational information in different operating scenarios can be analyzed in advance to select the target information. The specific implementation process is shown in FIG. 6.

FIG. 6 illustrates a flowchart for analyzing a plurality of pieces of operational information in advance for different operating scenarios and selecting target information consistent with various embodiments of the present disclosure. The process may include steps 601 through 604, which are described in detail below.

601: obtaining a plurality of operating parameters of the target device in at least two operating scenarios.

In the at least two operating scenarios, heat generation of the target device differs among the scenarios.

By controlling the electronic device during operation in each operating scenario, a plurality of pieces of operational information for the target device may be obtained. The operational information can characterize an operating condition of the target device in a corresponding operating scenario and can also characterize the cooling demand of the target device.

Each piece of operational information may indicate the cooling demand of the target device in a corresponding operating scenario. However, different pieces of operational information have different degrees of correlation with the cooling demand of the target device. Accordingly, an operational information combination having a highest correlation with the cooling demands may be selected to determine target information.

The operating scenario can include movie viewing, office work, gaming, big data inference, and the like.

602: determining, based on the plurality of pieces of operational information of the target device, at least one piece of correlated information for the target device.

The plurality of pieces of operational information is combined to obtain a plurality of operational information combinations.

In one embodiment, the plurality of pieces of operational information can be combined in pairs. If there are A pieces of operational information, (A-1) operational information combinations are obtained.

In another embodiment, the plurality of pieces of operational information can be combined in groups of more than two to obtain operational information combinations.

In another embodiment, the plurality of pieces of operational information can be combined sequentially in pairs and in groups of more than two to obtain a plurality of operational information combinations.

In one possible implementation, each piece of operational information in each of operational information combinations can be processed using at least one processing method to obtain at least one piece of correlated information for the target device.

The processing method can be a mathematical calculation, in which values of the pieces of operational information in an operational information combination are mathematically processed to obtain a corresponding value of the related information.

For example, the processing method can be any addition, subtraction, multiplication, division, or any combination thereof. Other calculation methods are also possible and are not limited by the present disclosure.

By processing the pieces of operational information within each operational information combination, processed information can be obtained and used as correlated information for the target device.

An operational information combination is determined from the plurality pieces of operational information obtained, where the combination includes two or more pieces of operational information.

Each piece of operational information within the operational information combination is processed to determine the target information. Different operational information combinations can determine different target information.

For example, when the target device is a chip-on-board device, the operational information of the target device may include chip temperature, chip current, chip power consumption, onboard temperature, onboard current, and the like. The target information may be determined based on, for example: chip temperature and chip current; chip temperature and onboard temperature; chip load and onboard temperature, or chip temperature, chip current, chip power consumption, and onboard temperature, among other combinations.

The target information is determined by a plurality of pieces of operational information in an operational information combination. It can be obtained by calculating the operational information using a specific method, and the target information integrates the plurality of pieces of operational information from the operational information combination.

The operational information combination corresponding to the target information can be predetermined. When the operational information combination is obtained, specific pieces of operational information corresponding to the operational information combination may be retrieved and the operational information combination can be directly processed to determine the target information, thereby reducing a data processing burden.

603: determining changes of correlated information of the target device in a first operating scenario and a second operating scenario, a cooling demand of the first operating scenario differing from a cooling demand of the second operating scenario.

For two operating scenarios with different cooling demands, changes in correlated information of the target device across the two scenarios can be determined.

The changes in the correlated information across the two operating scenarios may indicate a sensitivity of the correlated information to changes in cooling demand.

If changes in the correlated information differ between the two operating scenarios, the correlated information may exhibit a larger change in one operating scenario and a smaller change, or substantially no change, in the other operating scenario.

If the correlated information differs between operating scenarios having a high cooling demand and operating scenarios having a low cooling demand, for example, increasing in operating scenarios having a high cooling demand and remaining substantially stable in operating scenarios having a low cooling demand, the correlated information can be used to determine a change in operating scenario, and a corresponding change in cooling demand of the target device may be determined.

If the correlated information is the same in operating scenarios with a high cooling demand and operating scenarios having a low cooling demand, for example, if the correlated information remains constant in both scenarios, or increases or decreases synchronously in both two scenarios, it may be difficult to determine changes in cooling demand based on the correlated information.

The first operating scenario and the second operating scenario can be chosen to represent different cooling demands. For example, the first operating scenario might have a high cooling demand, while the second operating scenario has a low cooling demand.

For instance, scenarios such as watching movies or office work have low cooling demands, while operating scenarios such as gaming or big-data inference have high cooling demands for the target device.

604: determining that correlated information is the target information when a change in the correlated information between the first operating scenario and the second operating scenario exceeds a predetermined variation threshold.

The predetermined variation threshold is a value that can distinguish between two different situations. If the change exceeds the predetermined variation threshold, it can be determined that the correlated information changes significantly between the two operating scenarios. If the change does not exceed the predetermined variation threshold, it can be determined that the correlated information changes only slightly between the two operating scenarios.

Specifically, if a change in a specific piece of correlated information between the first operating scenario and the second operating scenario exceeds the predetermined variation threshold, the piece of correlated information indicates a significant difference between the two operating scenarios, and can be used to distinguish cooling demands of the two operating scenarios. Otherwise, the piece of correlated information may be unsuitable corresponding to distinguishing cooling demands of the two operating scenarios.

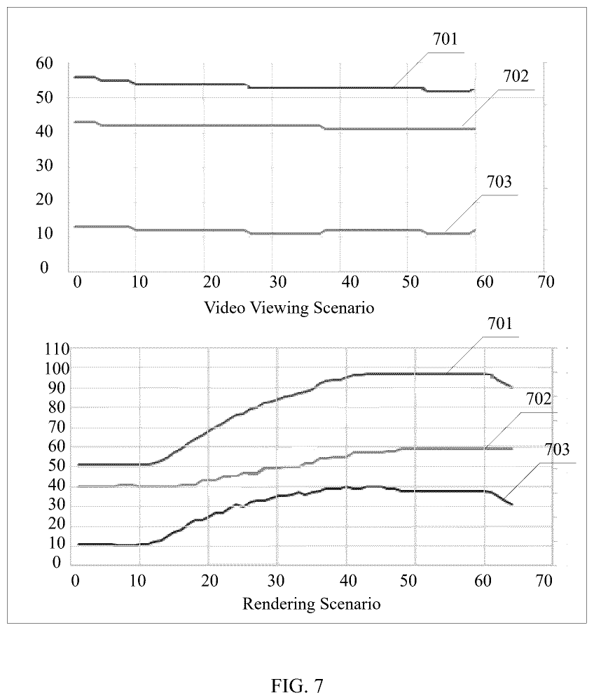

FIG. 7 illustrates a schematic diagram of combined operational information and target information curves for two operating scenarios consistent with various embodiments of the present disclosure. The two operating scenarios can be a video viewing scenario and a rendering scenario. For example, an operational information combination includes a CPU temperature and a board temperature, and the target information can be a temperature difference between the CPU temperature and the board temperature. In FIG. 7, a CPU temperature curve 701, a board temperature curve 702, and a target information curve 703 are illustrated. A horizontal axis represents time in seconds, and a vertical axis represents temperature in °C. In the video viewing scenario, the temperature difference remains stable and below 15 °C. In the rendering scenario, the temperature difference increases and stabilizes above 15 °C after 15 seconds.

FIG. 8 illustrates a schematic diagram of combined operational information and target information for two operating scenarios, along with corresponding curves for operating parameters consistent with various embodiments of the present disclosure. The operating scenarios are a video playback scenario and a rendering scenario. The operational information includes a CPU temperature and a board temperature, and the target information is a temperature difference between the CPU temperature and the board temperature. In FIG. 8, a curve 801 represents the CPU temperature, a curve 802 represents the board temperature, a curve 803 represents the target information (temperature difference), and a curve 804 represents the fan speed. A horizontal axis represents time in seconds, and a vertical axis represents temperature in °C. In the video playback scenario, the temperature difference remains stable below 15 °C, and the fan speed remains stable at about 2100 rpm. In the rendering scenario, the temperature difference stabilizes at above 15 °C after 15 seconds. The fan speed remains at about 1400 rpm for 15 seconds and gradually increases to about 4000 RPM after 15 seconds.

In one embodiment, a plurality of pieces of operational information for the target device are obtained in a plurality of operating scenarios. Based on the operational information, at least two operational information combinations are determined. Each piece of operational information in each combination is processed using at least one processing method to obtain at least one piece of correlated information of the target device. Changes in each piece of correlated information between a first operating scenario and a second operating scenario having different cooling demands are determined. Based on whether a change in any correlated information between the first and second operating scenarios exceeds a predetermined variation threshold, the piece of correlated information is determined as the target information. By comparing changes in correlated information in operating scenarios having different cooling demands, a piece of correlated information whose change exceeds the predetermined variation threshold may be determined as target information representing different cooling demands of the target device. The determined target information is consistent with the cooling demand of the target device, thereby improving accuracy of subsequently determining the cooling mode of the cooling module based on the target information.

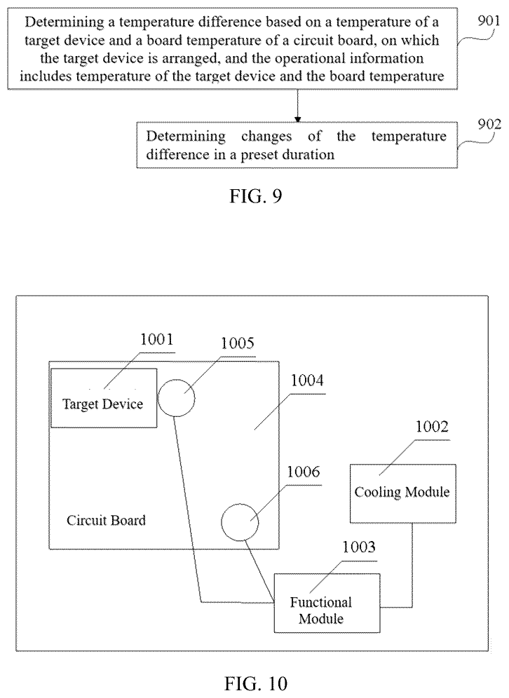

In one possible implementation, the target information is determined by a temperature difference between temperature of the target device and the board temperature, and changes in the target information are determined accordingly. The specific implementation process is shown in FIG. 9.

FIG. 9 illustrates a flowchart for analyzing target information and determining how the target information changes within a preset time frame consistent with various embodiments of the present disclosure. The process may include steps 901 to 902, which are described in detail below.

901: determining a temperature difference based on a temperature of a target device and a board temperature of a circuit board, on which the target device is arranged, and the operational information includes the temperature of the target device and the board temperature.

The target device can be a chip or another device mounted on the circuit board.

The circuit board may also include a plurality of temperature sensors. A temperature sensor near the target device is used to measure the temperature of the target device, while temperature sensors arranged further away from the target device can measure the board temperature of the circuit board at different locations.

During operation, the target device dissipates heat, and temperatures at other locations on the circuit board are affected by the cooling. Consequently, temperatures detected by temperature sensors arranged further away from the target device also increases accordingly.

While the target device is operating, the temperature of the target device and the board temperature of the circuit board are monitored to determine a temperature difference between the target device and the circuit board.

The temperature difference can be a difference between the temperature of the target device and the board temperature of the circuit board, an absolute value of the difference, or the like.

The temperature difference represents a temperature gap between the target device and the circuit board. A stable temperature difference indicates stable cooling of the target device and a low cooling demand; a larger temperature difference indicates increased cooling of the target device and a high cooling demand.

FIG. 10 illustrates another schematic diagram of an electronic device consistent with various embodiments of the present disclosure

The information determination method described above can be applied to an electronic device that includes a target device 1001, a cooling module 1002, and a functional module 1003. The target device 1001 can be mounted on a circuit board 1004, which may further include temperature sensors 1005 and 1006. The target device 1001 can be a device to be cooled, the cooling module 1002 may be configured to dissipate heat from the target device 1001, and the functional module 1003 may be configured to perform the configuration method described in the embodiments of the present disclosure. The temperature sensor 1005 can be arranged proximate to the target device 1001, and a temperature detected by the temperature sensor 1005 may be used as a temperature of the target device 1001. The temperature sensor 1006 can be arranged farther from the target device 1001, and a temperature detected by the temperature sensor 1006 may be used as a temperature of the circuit board 1004.

In a specific implementation, the temperature of the target device and the board temperature can be obtained in real time, and a temperature difference between the target device and the circuit board can be calculated based on real-time temperature readings.

902: determining changes of the temperature difference in a preset duration.

By determining a real-time temperature difference between the temperature of the target device and the board temperature, an overall temperature distribution on the circuit board can be determined. The temperature distribution corresponds to the cooling demands of the target device.

If the temperature difference remains stable in the preset duration, heat generation of the target device and heat dissipation of the target device are balanced, and the cooling demands are lower. If the temperature difference gradually increases, heat generation of the target device exceeds heat dissipation of the target device, that is, heat generation of the target device cannot be effectively dissipated, and the cooling demand is high. Accordingly, the cooling module may be controlled to provide greater cooling capacity. Based on changes in the temperature difference, the cooling demand of the target device may be determined, and the cooling module may be controlled to operate in a cooling mode corresponding to the determined cooling demand, thereby accurately controlling cooling based on operation of the target device.

Accordingly, if the temperature difference remains stable in a preset duration, the cooling demand is low, and the cooling module can be controlled to operate in the first cooling mode that provides a lower cooling capacity to the target device. If a temperature difference transitions from being stable to gradually increasing in the preset duration, the cooling demand of the target device has increased, and the cooling module can be controlled to switch to the second cooling mode that provides a higher cooling capacity to the target device.

In one possible implementation, a threshold may be set. If, within a preset period, a temperature difference transitions from being less than the threshold to being greater than the threshold, it is determined that the transition satisfies a trigger condition for the second cooling mode. Conversely, if, within the preset period, the temperature difference transitions from being greater than or equal to being less than the threshold, it is determined that the transition satisfies a trigger condition for the first cooling mode.

For example, the threshold can be set to 15 °C. A stable state may be defined as a temperature difference being within a preset temperature threshold, for example, less than or equal to 15 °C. A gradually increasing temperature difference may be defined as a temperature difference being outside the preset temperature threshold, for example, greater than 15 °C. The threshold may alternatively be set to other values, and the present application is not limited thereto.

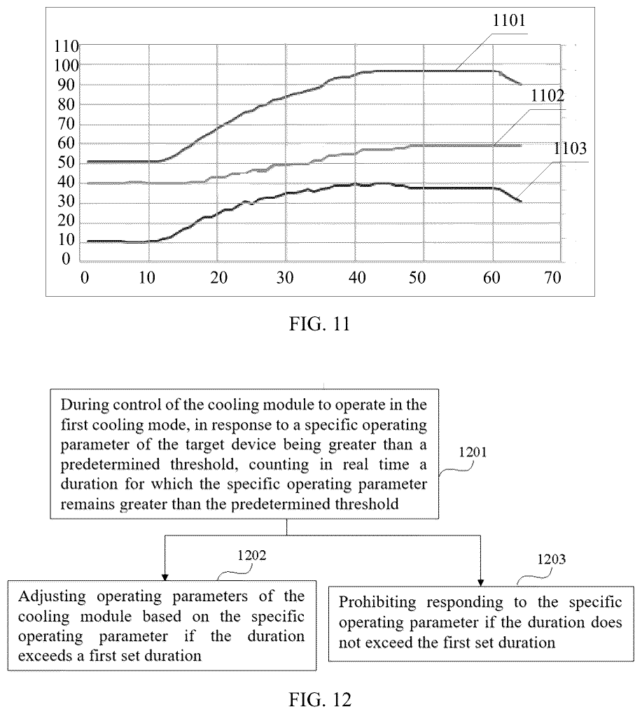

FIG. 11 illustrates a schematic diagram of curves of operational information and target information in an application scenario consistent with various embodiments of the present disclosure. In the application scenario, the target device is a CPU (central processing unit). The operational information includes a CPU temperature and a board temperature, and the target information includes a difference between the CPU temperature and the board temperature. As shown in FIG. 11, a curve 1101 represents the CPU temperature, a curve 1102 represents the board temperature, and a curve 1103 represents the target information. A horizontal axis represents time(s), and a vertical axis represents temperature (°C). The CPU temperature remains at 50 °C from 0 s to 12 s, increases rapidly after 12 seconds, reaches about 98 °C at about 44 seconds, and remains at the temperature for a period. The board temperature remains at 40 °C from 0 s to 18 s, increases gradually after 18 seconds, and stabilizes at around 60 °C at about 48 seconds. A change in board temperature lags a change in CPU temperature, and the board temperature remains lower than the CPU temperature. When both the CPU temperature and the board temperature remain stable, a difference between the CPU temperature and the board temperature remains constant, and the difference is less than 15 °C. When the CPU temperature rises rapidly, the board temperature may correspondingly increase in response to the CPU temperature change, while exhibiting a thermal lag. Because the board temperature does not rise as quickly as the CPU temperature, a change in the target information is smaller than a change in the CPU temperature, and the temperature difference may stabilize at above 15 °C. Accordingly, it may be determined that the temperature difference is more suitable corresponding to representing the cooling demand of the CPU.

In one embodiment, the target device is mounted on the circuit board, and the operational information includes the temperature of the target device and the board temperature. Based on the temperature of the target device and the board temperature of the circuit board, a temperature difference is determined and changes in the temperature difference in the preset duration are determined. By determining the temperature difference between the temperature of the target device and the board temperature of the circuit board, the cooling demand of the target device can be assessed. A smaller temperature difference indicates a lower cooling demand, while a larger temperature difference indicates a higher cooling demand. Accordingly, based on changes in the temperature difference, the cooling demand may be determined, and a cooling mode corresponding to the determined cooling demand may be selected for the cooling module, thereby enabling accurate control of cooling based on an operating condition of the target device. In one possible implementation, during operation of the cooling module in the first cooling mode, a response manner of the cooling module to a cooling demand caused by a sudden increase in power consumption may be determined based on the first target duration. The specific implementation process is shown in FIG. 12.

FIG. 12 illustrates a flowchart for determining a response method to sudden high power dissipation demands when the cooling module is operating in the first cooling mode consistent with various embodiments of the present disclosure. The process may include steps 1201 through 1203, which are described in detail below.

1201: during control of the cooling module to operate in the first cooling mode, in response to a specific operating parameter of the target device being greater than a predetermined threshold, counting in real time a duration for which the specific operating parameter remains greater than the predetermined threshold.

When the cooling module operates in the first cooling mode, the specific operating parameter of the target device may be continuously detected, and the specific operating parameters may characterize the cooling demand of the target device.

In one embodiment, since a higher load results in increased heat generation in the target device and higher cooling demand, the specific operating parameter can be a load of the target device.

In another embodiment, since a higher current results in more heat generation in the target device and a greater cooling demand, the specific operating parameter can also be a current of the target device.

If the specific operating parameter of the target device is detected to exceed a predetermined threshold, it indicates the target device has a sudden high-power cooling demand.

When the electronic device operates in the first cooling mode, a load of the target device is low, and the cooling module can achieve optimal cooling performance for the target device using a lower operating parameter. However, when a sudden high-power cooling demand occurs, responding to the sudden high-power cooling demand may involve increasing an operating parameter of the cooling module, which may increase noise generated by the electronic device. Accordingly, the method may include determining whether to respond to the sudden increase in cooling demand.

In one possible implementation, the predetermined threshold is a value configured to distinguish between a high load and a low load of the target device. If a load of the target device exceeds the predetermined threshold, the target device may be determined to be in a high-load state; otherwise, the target device may be determined to be in a low-load state.

A specific value of the predetermined threshold can be configured according to actual circumstances and is not limited herein.

If a specific operating parameter of the target device exceeds a predetermined threshold, it can be determined that the target device has a sudden high-power cooling demand. A duration for which the specific operating parameter remains above the predetermined threshold is recorded to determine whether a response to the sudden high-power cooling demand is necessary.

Therefore, a determination is made based on the first target duration set in the first cooling mode. If the duration exceeds the first target duration, the sudden high-power cooling demand persists for a longer period and a response is required. Otherwise, the sudden high-power cooling demand persists for a shorter period, and a response is not required.

1202: adjusting operating parameters of the cooling module based on the specific operating parameter if the duration exceeds a first set duration.

If the duration for which the specific operating parameter exceeds the predetermined threshold is greater than the first target duration, it may be determined that the high-load condition persists longer than a time during which a first operating parameter is maintained each time the first operating parameter is switched.

Since the specific operating parameter persists for a longer period, the first cooling mode may provide insufficient cooling, which may degrade performance of the target device. Accordingly, a response to the specific operating parameter may be required.

A response to the specific operating parameter includes adjusting operating parameters of the cooling module according to the specific operating parameter.

In one possible implementation, adjusting an operating parameter of the cooling module according to the specific operating parameter may include, when the specific operating parameter exceeds the predetermined threshold, selecting an operating parameter higher than a currently used first operating parameter. The selected operating parameter may correspond to the specific operating parameter, so that the cooling module switches an operating parameter thereof to the selected operating parameter to increase a cooling capacity of the cooling module.

In one possible implementation, when a duration for which a first operating parameter is maintained reaches the first target duration, execution of a step of obtaining operational information of the target device in the electronic device may be triggered based on a specific operating parameter.

Specifically, when a duration for which the first operating parameter is maintained reaches the first target duration, the target information is determined using the specific operating parameters, and the cooling mode is switched based on the target information.

For example, when the specific operating parameter is a load of the target device and a duration for which the load exceeds a set load threshold is greater than the first target duration corresponding to a current first cooling mode, a process for re-determining the cooling mode of the cooling module is triggered, a plurality of pieces of operational information of the target device is obtained, and the target information is determined. It is determined whether the target information satisfies the second condition, to determine whether to control the cooling module to operate in the second cooling mode, thereby increasing a cooling capacity of the cooling module.

For example, When the specific operating parameter is a current of the target device and a duration for which the current exceeds a preset current threshold is greater than the first target duration corresponding to a current first cooling mode, a process for re-determining a cooling mode of the cooling module is triggered, a plurality of pieces of operational information of the target device is obtained, and the target information is determined. It is determined whether the target information satisfies the second condition, to determine whether to control the cooling module to operate in the second cooling mode, thereby increasing a cooling capacity of the cooling module.

1203: prohibiting responding to the specific operating parameter if the duration does not exceed the first set duration.

If the duration for which the specific operating parameter exceeds the predetermined threshold is not greater than the first target duration, the duration of the specific operating parameter is shorter.

A shorter duration of a specific operating parameter represents a short duration of a sudden high-power cooling demand of the target device. The cooling module operating in the current first cooling mode can dissipate heat generated by a sudden high-power operation. Compared to a higher operating parameter, although a cooling capacity provided by a first cooling parameter in the first cooling mode may be lower, it may still be sufficient to satisfy the cooling demand for a short-duration condition. Accordingly, the electronic device may refrain from responding to the specific operating parameter, thereby reducing noise generated during operation.

In one embodiment, the specific operating parameter can be ignored to prohibit responding to the specific operating parameter.

Similarly, in one possible implementation, when the cooling module operates in the second cooling mode and a specific operating parameter exceeds the predetermined threshold, similar operation in the first cooling mode, the duration for which the specific operating parameter remains above the threshold can also be counted in real time. If the duration exceeds the second target duration, operating parameters of the cooling module is adjusted according to the specific operating parameter. An adjustment process may include selecting an operating parameter that is higher than a currently used second operating parameter. The selected operating parameter may correspond to the specific operating parameter, so that the cooling module switches the operating parameter thereof to the selected operating parameter to increase the cooling capacity of the cooling module. If the duration does not exceed the second target duration, the cooling module is prohibited from responding to the specific operating parameter.

In one embodiment, while the cooling module operates in the first cooling mode, a duration for which a specific operating parameter of the target device exceeds a predetermined threshold is counted in real time. If the duration exceeds the first target duration, operating parameters of the cooling module are adjusted according to the specific operating parameter. If the duration does not exceed the first target duration, the cooling module is prohibited from responding to the specific operating parameter. When the cooling module operates in the first cooling mode and a specific operating parameter of the target device exceeds a predetermined threshold, it is determined that a sudden high-power cooling demand occurs. The duration of the sudden high-power cooling demand is used to determine whether a response to the sudden high-power cooling demand is required. By refraining from responding when the sudden high-power condition persists for only a shorter duration, the cooling capacity in response to a sudden power-consumption may be minimized, thereby reducing operating noise of the electronic device. When the sudden high-power cooling demand persists for a longer duration, the cooling module may respond the sudden high-power cooling demand, thereby maintaining performance of the electronic device.

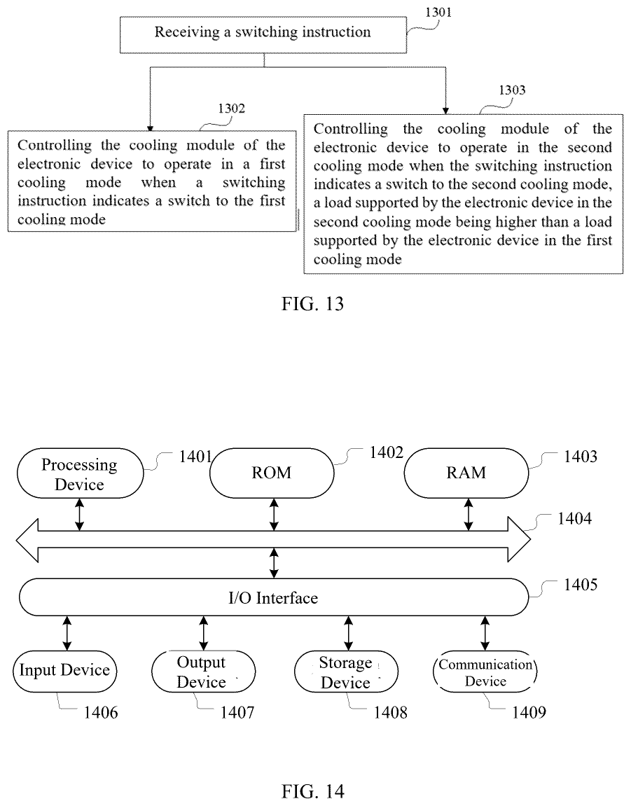

In one possible implementation, the electronic device can employ a plurality of manually switchable operating modes, each operating mode includes the two cooling modes described above. The detailed implementation is shown in FIG. 13.

FIG. 13 illustrates a flowchart for switching between operating modes of an electronic device consistent with various embodiments of the present disclosure. The process may include steps 1301 to 1303, which are described in detail below.

1301: receiving a switching instruction.

The electronic device has a plurality of operating modes, and accordingly, the cooling module in the electronic device has corresponding operating parameters for each mode. Each operating mode can be further subdivided into the two cooling modes described above.

Switching between the operating modes may be performed in response to a user switching operation.

In one embodiment, switching between operating modes can be performed using an input operation, for example, by a keyboard shortcut (e.g., an Fn+Q key combination) or by selecting a target operating mode via a user interface.

The cooling module supports a plurality of operating modes, and different operating modes may correspond to different workloads. By switching operating modes, the electronic device may control the cooling module to operate according to a cooling mode associated with the selected operating mode.

1302: controlling the cooling module of the electronic device to operate in a first cooling mode when a switching instruction indicates a switch to the first cooling mode.

If the switching instruction indicates switching to the first operating mode, the electronic device may control the cooling module to operate according to the first operating mode. In the first operating mode, the cooling module may operate in one of two cooling modes in the first operating mode.

After switching to the first operating mode, target information is determined based on a plurality of pieces of information obtained from the target device. Based on whether the target information satisfies the first condition or the second condition, the cooling module is controlled to operate in the first cooling mode or the second cooling mode.

A method for selecting the first cooling mode in the first operating mode may be implemented with reference to FIG. In one example, in response to the operational information satisfying the first condition, the first control table including the first cooling mode is obtained.

Similarly, the method for selecting the second cooling mode in the first operating mode may be implemented in a manner like the method for selecting the first cooling mode and is not described in detail herein.

1303: controlling the cooling module of the electronic device to operate in the second cooling mode when the switching instruction indicates the switch to the second cooling mode, a load supported by the electronic device in the second cooling mode being higher than a load supported by the electronic device in the first cooling mode.

If the switching instruction indicates a switch to the second operating mode, the cooling module of the electronic device can be controlled to operate in the second operating mode, specifically using one of the two cooling modes within the second operating mode.

After switching to the second operating mode, target information is determined based on a plurality of pieces of information obtained from the target device. Based on whether the target information satisfies the first condition or the second condition, the cooling module is controlled to operate in the first cooling mode or the second cooling mode.

The method for selecting the first cooling mode in the second operating mode can be implemented as described in the above embodiments. For example, when the operational information satisfies the first condition, the first control table including the first cooling mode may be obtained.

Similarly, the method for selecting the second cooling mode in the second operating mode can be implemented in a manner like the method for selecting the first cooling mode and is not described in detail herein.

In one embodiment, a switching instruction is received. In response to the switching instruction indicating switching to the first operating mode, the cooling module of the electronic device is controlled to operate in the first operating mode. In response to the switching instruction indicating switching to a second operating mode, the cooling module of the electronic device is controlled to operate in the second operating mode. A load supported by the electronic device in the second operating mode is higher than a load supported by the electronic device in the first operating mode. The electronic device switches among different operating modes of the electronic device. After receiving the switching instruction, the electronic device determines the target operating mode and controls the cooling module of the electronic device to operate in a corresponding operating mode. The electronic device selects a cooling mode in the operating mode for more precise control of the cooling module, thereby achieving accurate control of the cooling for the target device.

The above describes a configuration method provided by the embodiments of the present disclosure. The following will describe a device for performing the above configuration method.

In one embodiment, a configuration device is provided. The configuration device is used to configure either a first cooling mode or a second cooling mode as a cooling mode for an electronic device. The first cooling mode includes a first control table, and the second cooling mode includes a second control table.

The first control table includes N different switchable first operating parameters, where N is greater than 1. After switching to any one of the N first operating parameters, the selected first operating parameter is maintained for a first target duration. A lower limit value of each of the N first operating parameters is a first value.

The second control table includes M different switchable second operating parameters, where M is greater than 1. After switching to any one of the M second operating parameters, the selected second operating parameter is maintained for a second target duration. A lower limit value of each of the M second operating parameters is a second value. M may be equal to N or different from N. The first operating parameters and the second operating parameters may characterize cooling capacity of the cooling module in the respective cooling modes.

The first target duration is greater than the second target duration, and any first value in the first control table is less than any second value in the second control table.

In one embodiment, the configuration device includes a first control module, configured to control the cooling module to operate in the first cooling mode when the target information satisfies a first condition; or a second control module, configured to control the cooling module to operate in the second cooling mode when the target information satisfies a second condition. A cooling demand of the second condition is greater than a cooling demand of the first condition.

In one embodiment, based on the target information satisfying the first condition, the cooling module is controlled to operate in the first cooling mode. The configuration device includes: a first determination module, configured to determine a current operating mode of the electronic device, different operating modes supporting different load levels, the first target duration corresponding to an operating modes being negatively correlated with a load supported by the electronic device; a second determination module, configured to determine the first cooling mode corresponding to the current operating mode when target information satisfies the first condition; a first acquisition module, configured to determine the first control table corresponding to the first cooling mode for the current operating mode; and a switching module, configured to switch operating parameters of the cooling module based on first operating parameters in the first control table, and to maintain the first target duration after switching.

In one embodiment, the configuration device further includes: a third determination module, configured to determine a change of the target information in the preset duration based on the target information, the target information being determined based on at least part of at least two pieces of operational information, and a degree of correspondence between the target information and the cooling demand of the target device being higher than a degree of correspondence between any single piece of the operational information and the cooling demand; and a fourth determination module, configured to satisfy, based on the change of the target information, a trigger condition of the first cooling mode, to determine that the operating parameters satisfy the first condition, and to control the cooling module to operate in the first cooling mode; or, configured to satisfy, based on the change of the target information, a trigger conditions of the second cooling mode, and to determine that the target information satisfies the second condition, and the cooling demand of the second condition being greater than the cooling demand of the first condition.

In one embodiment, the configuration device further includes: a second acquisition module, configured to obtain a plurality of operational information of the target device in the electronic device; and a fifth determination module, configured to determine target information based on a combination of at least two pieces of operational information among a plurality of pieces of operational information, different operational information resulting in different target information, the target information being capable to characterize the cooling demands of the target device and the target information being used to control operation of the cooling module in the electronic device.

In one embodiment, the configuration device further includes: a third acquisition module, configured to obtain operational information of the target device in at least two operating scenarios; a sixth determination module, configured to determine at least one piece of correlated information of the target device based on the operational information of the target device; a seventh determination module, configured to determine changes in respective pieces of correlated information of the target device between a first operating scenario and a second operating scenario, cooling demands of the first operating scenario and the second operating scenario being different; and an eighth determination module, configured to determine that a piece of correlated information is target information if a change in the piece of correlated information between the first operating scenario and the second operating scenario exceeds a predetermined threshold.

In one embodiment, the fourth determination module includes: a first determination unit, configured to determine a temperature difference based on a temperature of the target device and a board temperature of a circuit board on which the target device is mounted, and the operational information including the temperature of the target device and the board temperature; and a second determination unit, configured to determine changes in the temperature difference in the preset duration.

In one possible implementation, the configuration device further includes a statistics module, configured to continuously monitor, while the cooling module operates in the first cooling mode, a duration for which a specific operating parameter of the target device exceeds a predetermined threshold; an adjustment module, configured to adjust operating parameters of the cooling module based on the specific operating parameters if the duration exceeds a first set duration; and a disabling module, configured to prohibit responding to the specific operating parameter if the duration does not exceed the first set duration.

In one possible implementation, the adjustment module is specifically configured to trigger execution of a step of obtaining operational information of the target device in the electronic device when a duration for which a first operating parameter is maintained after switching reaches the first target duration and further based on a specific operating parameter.

In one possible implementation, the configuration device further includes: a receiving module, configured to receive a switching instruction; a third control module, configured to control the cooling module of the electronic device to operate in the first cooling mode based on the switching instruction; and a fourth control module, configured to control the cooling module of the electronic device to operate in the second cooling mode based on the switching instruction, the electronic device supporting a higher load in the second cooling mode than in the first cooling mode.

It should be noted that functions of the respective modules in the configuration device correspond to functions described in the method embodiments described above and are not repeated herein.

In one embodiment, the configuration device configures an electronic device to operate in a first cooling mode or a second cooling mode. Different control tables are provided for different cooling modes. A first control table corresponding to the first cooling mode includes N different switchable first operating parameters. After each switch, a selected first operating parameter is maintained for a first target duration, and a lower limit value of each of the N first operating parameters is a first value. A second control table corresponding to the second cooling mode includes M different switchable second operating parameters. After each switch, a selected second operating parameter is maintained for a second target duration, and a lower limit value of each of the M second operating parameters is a second value. M and N are the same or different positive integers. The first target duration is greater than the second target duration, and any first value in the first control table is less than any second value in the second control table. In the first cooling mode, a first operating parameter having a lower lower-limit value and a longer maintenance duration are set. When the cooling module is in the first cooling mode, the cooling module can minimize the cooling demand in response to a sudden large power consumption, thereby reducing operating noise of the electronic device. In the second cooling mode, a second operating parameter having a higher lower-limit value and a shorter maintenance duration are set. When the cooling module operates in the second heat dissipation mode, the cooling module may respond more quickly to a sudden high-power cooling demand, thereby maintaining performance of the electronic device.

An electronic device is provided in one embodiment of the present disclosure. FIG. 14 illustrates a schematic diagram of an electronic device suitable corresponding to implementing the configuration method in the embodiments of the present disclosure. In the embodiment, the electronic device may include, but are not limited to, fixed terminals such as a mobile phone, a laptop, a personal digital assistant (PDA), a tablet, a desktop computer or the like. The electronic device illustrated in FIG. 14 is provided only as an example and should not be construed as limiting a functionality and a scope of the embodiments of the present disclosure.

As shown in FIG. 14, the electronic device may include a processing device (e.g., a central processing unit, a graphics processing unit or the like) 1401, which can perform various actions and processes according to programs stored in a read-only memory (ROM) 1402 or programs loaded from a storage device 1408 into a random-access memory (RAM) 1403. When the electronic device is powered on, RAM 1403 also stores various programs and data necessary for operation of the electronic device. The processing device 1401, ROM 1402, and RAM 1403 are interconnected via a bus 1404. An input/output (I/O) interface 1405 is also connected to the bus 1404.

In general, the following devices can be connected to the I/O interface 1405: input devices 1406, including, for example, touchscreens, touchpads, keyboards, mice, cameras, microphones, accelerometers, and gyroscopes; output devices 1407, including, for example, liquid crystal displays (LCDs), speakers, and vibrators; storage devices 1408, including, for example, memory cards and hard drives; and communication devices 1409. The communication device 1409 enables the electronic device to communicate wirelessly or via a wired connection with another device to exchange data. Although FIG. 14 illustrates an electronic device having various devices, implementation or availability of all illustrated devices is not required. More or fewer devices may alternatively be implemented or provided.

In one embodiment, a computer program product is provided, including computer-readable instructions that, when executed by an electronic device, enable the electronic device to perform any of the configuration methods provided in the present disclosure.

In one embodiment, a computer-readable storage medium is provided, which stores one or more computer programs. When the one or more computer programs are executed by an electronic device, the electronic device can perform any of the configuration methods provided in the present disclosure.

It should be noted that the device embodiments described above are merely illustrative. Units described as separate components may be physically separate or may be integrated, and units shown as modules may be implemented as physical units or as functional units. The units may be in one device or distributed across a plurality of network units. Depending on actual needs, some or all the modules can be selected to achieve objectives of the embodiments. In addition, in the device embodiment diagrams provided in the present disclosure, connections between indicate communicative coupling, which may be implemented by one or more communication buses or signal lines.

Based on the above description of the implementation methods, a person skilled in the art will understand that the present disclosure may be implemented by software in combination with general-purpose hardware, or may be implemented by dedicated hardware, such as application-specific integrated circuits, dedicated CPUs, dedicated memory, and dedicated components. In general, functions performed by a computer program may be implemented using corresponding hardware, and different hardware structures can be used to implement a same function, including analog circuits, digital circuits, and/or dedicated circuits. However, the present disclosure may be implemented as a software program. Based on the above, technical solutions of the present disclosure, or portions thereof that contribute to the art, may be embodied in the form of a software product. The software product may be stored on a computer-readable storage medium, such as a floppy disk, a USB flash drive, an external hard drive, read-only memory (ROM), random-access memory (RAM), a magnetic disk, or an optical disc, and may include instructions that, when executed by a computer device (e.g., a personal computer, a training device, or a network device), cause the computer device to perform the methods described in the embodiments of the present disclosure.

In the embodiments described above, functions may be implemented wholly or partially by software, hardware, firmware, or any combination thereof. When implemented by software, the functions may be implemented wholly or partially in the form of a computer program product.

The computer program product includes one or more computer instructions. When the computer instructions are loaded and performed on a computer, all or part of the processes or functions according to the embodiments of the present disclosure are generated. a general-purpose computer, a special-purpose computer, a computer network, or another programmable apparatus. The computer instructions may be stored in a computer-readable storage medium or transmitted from one computer-readable storage medium to another computer-readable storage medium. For example, the computer instructions may be transmitted from a website, a computer, a training device, or a data center to another website, computer, training device, or data center via a wired manner (e.g., a coaxial cable, an optical fiber, or a digital subscriber line (DSL)) or a wireless manner (e.g., infrared, wireless, microwave, or the like). The computer-readable storage medium may be any available medium that can be stored by a computer, or a data storage device such as a training device or a data center that integrates one or more available media. The available media may include magnetic media (e.g., a floppy disk, a hard disk, or a magnetic tape), optical media (e.g., a DVD), or semiconductor media (e.g., a solid state disk (SSD)), and the like.

As disclosed, the configuration method provided by the present disclosure at least realizes the following beneficial effects.

The configuration method disclosed in the present disclosure improves cooling of an electronic device by coordinating at least a first cooling mode and a second cooling mode using differentiated control strategies, thereby achieving an improved balance between noise and cooling capability. In the first cooling mode, the cooling module maintains a switched first operating parameter for the first target duration after a switch, and for a sudden high-power cooling demand having a duration shorter than the first target duration, the cooling module is configured to refrain from switching operating parameters, thereby maintaining a lower noise level of the electronic device. In the second cooling mode, the cooling module operates with a greater cooling capacity and a shorter target duration, such that the cooling module is enabled to respond more quickly to a sudden high-power cooling demand and maintain the electronic device at an optimal performance level (including supporting a higher load than in the first cooling mode). Further, by determining target information based on a combination of at least two pieces of operational information, the method more accurately reflects changes in cooling demand than reliance on a single parameter, thereby improving control accuracy and stability and enabling more suitable cooling-mode selection and operating-parameter switching.

What is claimed is:

1. A configuration method, comprising:
configuring an electronic device to operate in one of a first cooling mode and a second cooling mode, wherein:
the first cooling mode includes a first control table, and the second cooling mode includes a second control table;
the first control table includes N switchable, mutually different first operating parameters, where N is greater than 1, upon switching from one first operating parameter to another first operating parameter, the electronic device maintains the switched first operating parameter for a first target duration, a lower limit value of a first operating parameter of the first operating parameters is a first value;
the second control table includes M switchable, mutually different second operating parameters, where M is greater than 1, upon switching from one second operating parameter to another second operating parameter, the electronic device maintains the switched second operating parameter for a second target duration, a lower limit value of the second operating parameter of the second operating parameters is a second value, M is the same as or different from N, the first operating parameters characterize a cooling capability of the first cooling mode and the second operating parameters characterize a cooling capability of the second cooling mode;
the first target duration is greater than the second target duration; and
any first value in the first control table is less than any second value in the second control table.

2. The method according to claim 1, wherein configuring the electronic device to operate in one of the first cooling mode and the second cooling mode includes:
controlling a cooling module to operate in the first cooling mode when target information satisfies a first condition; or
controlling the cooling module to operate in the second cooling mode when the target information satisfies a second condition, a cooling demand of the second condition being greater than a cooling demand of the first condition, and the target information being capable of characterizing a cooling demand of a target device in the electronic device.

3. The method according to claim 2, wherein controlling the cooling module to operate in the first cooling mode when the target information satisfies the first condition includes:
determining a current operating mode of the electronic device, the electronic device supporting different loads in different operating modes, different operating modes corresponding to different first target durations, different first target durations corresponding to different operating modes; and a first target duration corresponding to an operating mode being negatively correlated with a load supported by the electronic device;
determining a first cooling mode corresponding to the current operating mode when the target information satisfies the first condition;
obtaining, for the current operating mode, a first control table included in the first cooling mode; and
switching an operating parameter of the cooling module according to a first operating parameter in the first control table and maintaining the switched operating parameter for the first target duration after switching.

4. The method according to claim 2, further comprising:
determining changes of the target information in a preset duration based on the target information, a degree of fit between the target information and a cooling demand of the target device being higher than a degree of fit between any piece of operational information and the cooling demand of the target device;
determining that the target information satisfies the first condition when the changes satisfies a trigger condition of the first cooling mode; and
determining that the target information satisfies the second condition when the change satisfies a trigger condition of the second cooling mode, a cooling demand of the second condition being greater than a cooling demand of the first condition.

5. The method according to claim 1, further comprising:
obtaining a plurality of pieces of operational information of a target device in the electronic device; and
determining the target information based on a combination of at least two pieces of the plurality of pieces of operational information, different combinations of the at least two pieces of the operational information yielding different target information, the target information characterizing a cooling demand of the target device, and the target information being used to control operation of the cooling module of the electronic device.

6. The method according to claim 1, further comprising:
obtaining operational information of a target device in at least two operating scenarios including a first operating scenario and a second operating scenario;
determining, based on the operational information of the target device, at least one piece of correlated information of the target device;
determining a change amount of a piece of the correlated information of the target device between the first operating scenario and the second operating scenario, and a cooling demand of the first operating scenario being different from a cooling demand of the second operating scenario; and
determining that the piece of the correlated information is the target information when the change amount of the piece of the correlated information between the first operating scenario and the second operating scenario exceeds a set variation threshold.

7. The method according to claim 5, wherein determining the changes of the target information within the preset duration based on the at least two pieces of operational information includes:
determining a temperature difference based on a temperature of the target device and a board temperature of a circuit board, the target device being arranged on the circuit board, and the operational information including the temperature of the target device and the board temperature of the circuit board; and
determining changes of the temperature difference in the preset duration.

8. The method according to claim 2, further comprising:
counting in real time a duration for which a specific operating parameter remains greater than a predetermined threshold during controlling the cooling module to operate in the first cooling mode when the specific operating parameter of the target device exceeds the predetermined threshold;
adjusting operating parameters of the cooling module based on the specific operating parameter of the target device if the duration exceeds a first set duration; and
prohibiting responding to the specific operating parameter if the duration does not exceed the first set duration.

9. The method according to claim 8, wherein adjusting the operating parameter of the cooling module based on the specific operating parameter of the target device if the duration exceeds the first set duration includes:
triggering, in response to a maintained duration of switching to any first operating parameter reaching the first target duration, execution of a step of obtaining operational information of the target device in the electronic device based on the specific operating parameter.

10. The method according to claim 1, further comprising:
receiving a switching instruction;
controlling a cooling module of the electronic device to operate in a first cooling mode based on the switching instruction indicating switching to the first cooling mode;
controlling the cooling module of the electronic device to operate in a second cooling mode based on the switching instruction indicating switching to the second cooling mode; and
the electronic device supporting a higher load in the second cooling mode than in the first cooling mode.

11. An electronic device, comprising:
one or more processors and a memory storing computer programs that, when being executed, cause the one or more processors to perform:
configuring an electronic device to operate in one of a first cooling mode and a second cooling mode, wherein:
the first cooling mode includes a first control table, and the second cooling mode includes a second control table;
the first control table includes N switchable, mutually different first operating parameters, where N is greater than 1, upon switching from one first operating parameter to another first operating parameter, the electronic device maintains the switched first operating parameter for a first target duration, a lower limit value of a first operating parameter of the first operating parameters is a first value;
the second control table includes M switchable, mutually different second operating parameters, where M is greater than 1, upon switching from one second operating parameter to another second operating parameter, the electronic device maintains the switched second operating parameter for a second target duration, a lower limit value of the second operating parameter of the second operating parameters is a second value, M is the same as or different from N, the first operating parameters characterize a cooling capability of the first cooling mode and the second operating parameters characterize a cooling capability of the second cooling mode;
the first target duration is greater than the second target duration; and
any first value in the first control table is less than any second value in the second control table.

12. The device according to claim 11, wherein the one or more processors are further configured to perform:
controlling a cooling module to operate in the first cooling mode when target information satisfies a first condition; or
controlling the cooling module to operate in the second cooling mode when the target information satisfies a second condition, a cooling demand of the second condition being greater than a cooling demand of the first condition, and the target information being capable of characterizing a cooling demand of a target device in the electronic device.

13. The device according to claim 12, wherein the one or more processors are further configured to perform:
determining a current operating mode of the electronic device, the electronic device supporting different loads in different operating modes, different operating modes corresponding to different first target durations, different first target durations corresponding to different operating modes; and a first target duration corresponding to an operating mode being negatively correlated with a load supported by the electronic device;
determining a first cooling mode corresponding to the current operating mode when the target information satisfies the first condition;
obtaining, for the current operating mode, a first control table included in the first cooling mode; and
switching an operating parameter of the cooling module according to a first operating parameter in the first control table and maintaining the switched operating parameter for the first target duration after switching.

14. The device according to claim 12, wherein the one or more processors are further configured to perform:
determining changes of the target information in a preset duration based on the target information, a degree of fit between the target information and a cooling demand of the target device being higher than a degree of fit between any piece of operational information and the cooling demand of the target device;
determining that the target information satisfies the first condition when the changes satisfies a trigger condition of the first cooling mode; and
determining that the target information satisfies the second condition when the change satisfies a trigger condition of the second cooling mode, a cooling demand of the second condition being greater than a cooling demand of the first condition.

15. The device according to claim 11, wherein the one or more processors are further configured to perform:
obtaining a plurality of pieces of operational information of a target device in the electronic device; and
determining the target information based on a combination of at least two pieces of the plurality of pieces of operational information, different combinations of the at least two pieces of the operational information yielding different target information, the target information characterizing a cooling demand of the target device, and the target information being used to control operation of the cooling module of the electronic device.

16. The device according to claim 11, wherein the one or more processors are further configured to perform:
obtaining operational information of a target device in at least two operating scenarios including a first operating scenario and a second operating scenario;
determining, based on the operational information of the target device, at least one piece of correlated information of the target device;
determining a change amount of a piece of the correlated information of the target device between the first operating scenario and the second operating scenario, and a cooling demand of the first operating scenario being different from a cooling demand of the second operating scenario; and
determining that the piece of the correlated information is the target information when the change amount of the piece of the correlated information between the first operating scenario and the second operating scenario exceeds a set variation threshold.

17. The device according to claim 15, wherein the one or more processors are further configured to perform:
determining a temperature difference based on a temperature of the target device and a board temperature of a circuit board, the target device being arranged on the circuit board, and the operational information including the temperature of the target device and the board temperature of the circuit board; and
determining changes of the temperature difference in the preset duration.

18. The device according to claim 12, wherein the one or more processors are further configured to perform:
counting in real time a duration for which a specific operating parameter remains greater than a predetermined threshold during controlling the cooling module to operate in the first cooling mode when the specific operating parameter of the target device exceeds the predetermined threshold;
adjusting operating parameters of the cooling module based on the specific operating parameter of the target device if the duration exceeds a first set duration; and
prohibiting responding to the specific operating parameter if the duration does not exceed the first set duration.

19. The device according to claim 18, wherein the one or more processors are further configured to perform:
triggering, in response to a maintained duration of switching to any first operating parameter reaching the first target duration, execution of a step of obtaining operational information of the target device in the electronic device based on the specific operating parameter.

20. A non-transitory computer readable storage medium containing computer programs that, when being executed, cause at least one processor to perform:
configuring an electronic device to operate in one of a first cooling mode and a second cooling mode, wherein:
the first cooling mode includes a first control table, and the second cooling mode includes a second control table;
the first control table includes N switchable, mutually different first operating parameters, where N is greater than 1, upon switching from one first operating parameter to another first operating parameter, the electronic device maintains the switched first operating parameter for a first target duration, a lower limit value of a first operating parameter of the first operating parameters is a first value;
the second control table includes M switchable, mutually different second operating parameters, where M is greater than 1, upon switching from one second operating parameter to another second operating parameter, the electronic device maintains the switched second operating parameter for a second target duration, a lower limit value of the second operating parameter of the second operating parameters is a second value, M is the same as or different from N, the first operating parameters characterize a cooling capability of the first cooling mode and the second operating parameters characterize a cooling capability of the second cooling mode;
the first target duration is greater than the second target duration; and
any first value in the first control table is less than any second value in the second control table.
